(19) United States
(12) Patent Application Publication
(10) Pub. No.: US 2008/0002673 A1
(43) Pub. Date: Jan. 3, 2008

(54) Apparatus and system for localized multi-media communications and network

(76) Inventor: Don Smitheimer, Morganville, NJ (US)

Correspondence Address: VONAGE, 23 MAIN STREET, HOLMDEL, NJ, 07733, US

(21) Appl. No.: 11/824,016

(22) Filed: Jun. 27, 2007

Related U.S. Application Data
(60) Provisional application No. 60/817,394, filed on Jun. 30, 2006.

(51) Int. Cl. H04L 12/66

(52) U.S. Cl. 370/352

(57) ABSTRACT

Apparatus and system for multi-stage media communications includes a handheld wireless means for transmitting and receiving multi-media communications and a base station means for relaying the multi-media communications to a multi-media communications service provider. The handheld wireless means is repeatably configurable to any one of a plurality of users associated with the system. The communications service provider includes a proxy server for receiving and directing communications requests and a plurality of communications servers each providing access to a different form of media/communications. The base station means has one or more connection means to third party communication service providers that provides email services, web-browsing service IM services and the like. As such, a localized environment can exploit wireless capabilities for a variety of users having a variety of default preferences without incurring extra charges for multiple phone lines or assigning dedicated devices to each user.

### CROSS-REFERENCE TO RELATED APPLICATIONS

This application claims priority to U.S. Provisional Patent Application Ser. No. 60/817,394, filed Jun. 30, 2006, which is incorporated by reference herein in its entirety.

### FIELD OF THE INVENTION

The invention is related to the field of telecommunication devices and services and more specifically, the invention is directed to an apparatus and system for establishing multi-media communication sessions in a localized environment or network with generic, yet personalizable communication devices.

### BACKGROUND OF THE INVENTION

Existing communication systems such as Public Switched Telephone System (PSTN) and cell-based telephony systems can be used to connect one party to another (“one-to-one”) or connect many party's together (such as a conference or “many-to-many”). However, each system has inherent flaws and drawbacks when used some environments (e.g., a residential, small business or similar setting where there are potentially many users and one or relatively fewer available phone lines than users). Particularly, the PSTN is a hardwired system and, as such, is not mobile. Over the years, attempts have been made to improve mobility of the PSTN with devices like the cordless phone; however, even these improvements are limited in their end result. Specifically, data transmission rates and or power levels of PSTN-based cordless phone devices may still not provide sufficient call quality in a large enough area about the residence to consider their use a solution to the mobility problem. Cell-phone based telephony systems provide a greater degree of mobility. However, signal strength that is required for repeatable and acceptable levels of call quality is not always uniform when the cell phone is used in certain types of structures. Hence, the user of such a device must move from one area of a given structure to another for the purpose of finding an improved (i.e., unobstructed) signal path.

Moreover, regardless of the type of device or network used for telecommunications, the user is most likely interacting with a generic device to access the intended communications network. Examples of such generic devices are a basic PSTN telephone operated by loop voltage in a manner known to those skilled in the art. Such a device has very limited capabilities for enhanced/personalized telecommunication functions available today such as voicemail, email, memory/directories, speed dialing and the like. Additionally, PSTN use in a residence setting is limited to the number of lines available in the residence. Typical residence use includes one or two PSTN lines with a per line charge being incurred. As such, the maximum number of users in a residence PSTN setting is governed by the number of PSTN lines. Cell phones are advanced in that many such devices have the aforementioned enhanced capabilities, but still lack an ability to be personalized to allow for quick and easy access to a variety of communication modes and/or features. That is, a user must first access a service or feature by dialing into a server controlling such service or feature. Then, the user must enter one or more user ID's or passwords to authenticate himself in order to gain access to the specific user profile/feature. This process must be repeated each time that the user desires to access the feature (or possibly other features). Additionally, usually only one cell phone is associated with a given wireless telephone line; therefore, the same problem of maximum users described earlier with respect to the hardwired PSTN example exists.

Accordingly, it would be desirable to have an apparatus and communication system that maximizes the number of users that are able to access communication sessions in a localized environment that are personalized to the user without having to repeatedly log in to various features/services and the like, yet still have the mobile capabilities that are enjoyed by users of modern technology.

### SUMMARY OF THE INVENTION

The disadvantages associated with the prior art are overcome by a apparatus and system for localized multi-media communications and a network for achieving same. The system includes a handheld wireless means for transmitting and receiving media communications and a base station means for relaying the media communications to a multi-media communications service provider. The handheld wireless means is repeatably configurable to any one of a plurality of users associated with the system. The transmitting and receiving of the media communications between the handheld wireless means and the base station means is via a two-stage communications protocol, a first RF-based stage and a second IP-based stage (preferably SIP).

The communications service provider also includes a proxy server for receiving and directing communications requests and a plurality of communications servers each providing access to a different form of media/communications. The plurality of communications servers may be a voicemail server, an Instant Messaging (IM) server and a media session server. The base station means also has one or more connection means to third party communication service providers that may provide email services, web-browsing service IM services and the like. The media is selected from the group consisting of audio, video, text/SMS messages and data.

The system of claim 1 wherein the handheld wireless means are repeatably configurable using security metrics that equate one user associated with the system to at least one user profile maintained at the communications service provider. The security metrics may be a biometric ID scan, a retinal ID scan, a thumbprint scan, a analog dial interface, a GPS location or a combination of one or more of these metrics.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a system level block diagram of an exemplary multi-media communications system in accordance with the present invention;

FIG. 2 is a schematic diagram of an exemplary mobile device (handheld) for use in the present invention;

FIG. 3 is a schematic diagram of an exemplary server device (base station) for use in the present invention;

FIG. 4 is a logical data flow/diagram of an exemplary mobile device and user registration process of the present invention;

FIG. 5 is a schematic diagram of an exemplary multi-media communications service provider that communicates with the present invention;

FIG. 6A illustrates a first exemplary handheld user interface;

FIG. 6B illustrates a second exemplary handheld user interface;

FIG. 7 is a chart depicting the various types of communication sessions that occur during operation of the subject invention;

FIG. 8 is a chart detailing the activity associated with a softphone application making an outgoing telephone call;

FIG. 9 is a chart detailing the activity associated with a softphone application involved in an incoming telephone call;

FIG. 10 is a chart detailing the activity associated with an email client application; and

FIG. 11 is a chart detailing the activity associated with a voicemail client application.

To facilitate understanding, identical reference numerals have been used, where possible, to designate identical elements that are common to the figures.

### DETAILED DESCRIPTION

One popular communication protocol is the Session Initiation Protocol (SIP) which is a signaling protocol for initiating, managing and terminating media (e.g., voice, data and video) sessions across packet based networks that typically use the Internet Protocol (IP) of which VoIP is an example. The details and functionality of SIP can be found in the Internet Engineering Task Force (IETF) Request for Comments (RFC) Paper No. 3261 entitled, “SIP: Session Initiation Protocol” herein incorporated in its entirety by reference. SIP establishes and negotiates a session, including the modification or termination of a session. It uses a location-independent address system feature in which called parties can be reached based on a party's name. SIP supports name mapping and redirection allowing users to initiate and receive communication from any location. As such, it presents a solution to the lack of personalization and flexibility problems of existing PSTN and mobile communication systems as described below. While SIP is a preferred protocol for the subject invention, other protocols are also applicable as known to those skilled in the art including but not limited to H.323 and MGCP. H.323 is an umbrella recommendation from the ITU Telecommunication Standardization Sector (ITU-T) that defines the protocols to provide audio-visual communication sessions on any packet network. Media Gateway Control Protocol (MGCP) is a protocol used within a distributed Voice over IP system and is defined in IETF RFC 3435.

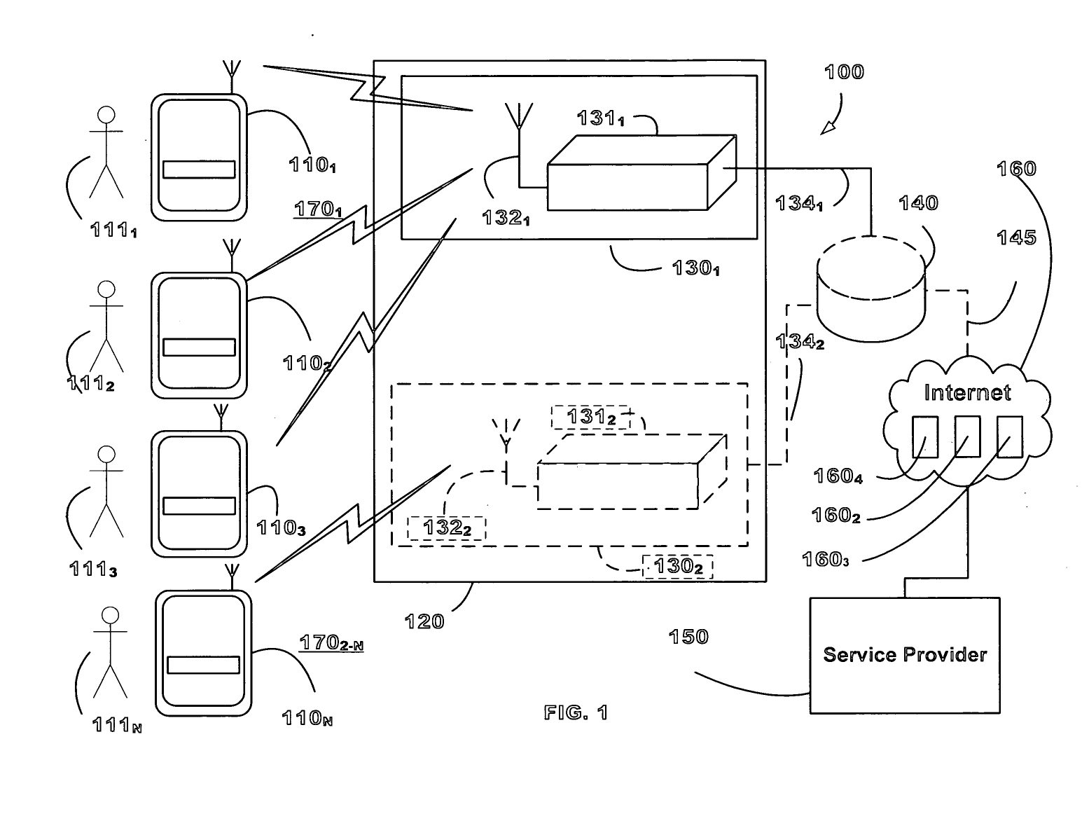

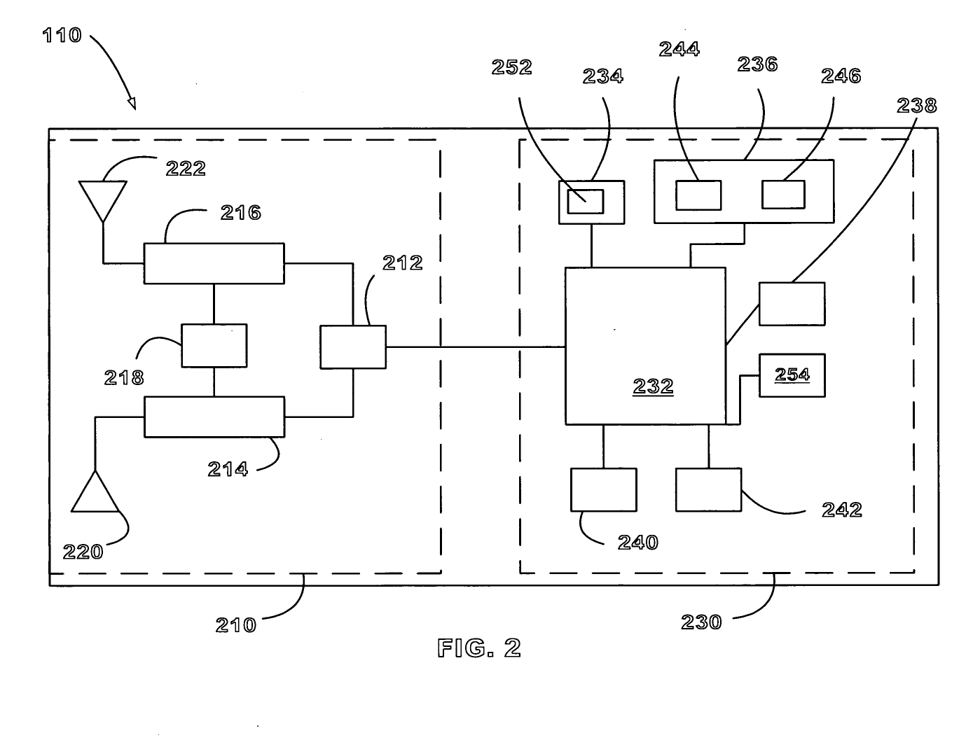

FIG. 1 is a system level block diagram depicting a localized multi-media communications system or network 100 according to an embodiment of the present invention. The system 100 includes a plurality of mobile communication devices 110ₓ, also known as handheld devices, which are used by a plurality of users 111ₓ for interaction with external content and service providers. The communication devices 110 are preferably microcontroller or microprocessor based as explained in greater detail below. The system 100 also includes a base station network 120 adapted to network the plurality of users 111ₓ across different geographically bounded regions. The users 111ₓ communicate with the external content and service providers via a two stage communication protocol. In one embodiment of the invention, the two stage communication protocol includes but is not limited to a Radio Frequency (RF) protocol, an ISM protocol, a DECT protocol and a SIP/IP protocol as explained in greater detail below.

The base station network 120 includes a plurality of base stations 130n interconnected by one or more packet-based network devices 140. The network device(s) 140 is adapted to receive one or more internal connections 134ₓ for connecting the plurality of base stations 130ₙ thereto and one or more external connection 145 for connecting the network device(s) 140 to one or more external networks such as but not limited to the public Internet 160. That is, external connections 145 are shown in broken-line format to indicate that they are not part of the subject invention and system 100, but may be optionally connected thereto to increase connectivity of the inventive system 100. Each base station 130n is provided with the necessary equipment (hardware and software) to transmit and receive two stage communication protocol signaling between two or more users 111ₓ. Specifically, each base station 130n includes a base station communication server 131, an antenna 132 and an internal network connection 134. While a plurality of base stations are shown (optionally in broken line format), a preferred embodiment of the invention includes only one base station means located in a central location of an environment in which the localized multi-media communications network is desired. Preferably, but not exclusively, such environment is a residence. A second or more base station means may be networked together to increase the range of the overall communications system 100 (i.e., to a garage or other outbuilding) as explained in greater detail below or to improve a failover condition should a base station cease to function.

The plurality of handheld devices 110ₓ, are manipulated by users 111ₓ, to communicate with one or more content and service providers 150x. A first local RF network 170₁, as defined herein consists of a Base Station 130 and a plurality handheld devices 110 which are capable of two-way RF communication. The Handheld devices 110 operate on the same or similar RF frequency as the base station 130ₓ and are connected to the base station 130 via an RF signaling protocol. The power output of an RF signal from the base station 130 and Handheld devices 110 coupled with the minimal power input of RF signal received by base station 130 and Handheld devices 110, defines the bounded geographical area defining the first local network 170₁, in which two-way RF communications is possible.

The subject invention provides the ability to expand the range of the first local RF network 107₁, to a second or more local RF networks 170₂₋ₙ. Essentially, the geographical area by which a plurality of handheld devices may communicate is increased by employing additional base stations 130₂, 130₃ . . . 130_{N} and interconnecting them via network device 140. In one embodiment of the invention, network device 140 is a Local Area Network (LAN) device such as a level 2 or level 3 switch as known in the art. Examples of such switches are the Catalyst 2960 manufactured and sold by Cisco Systems, Inc. of San Jose, Calif. and Biglron RX series layer 2/3 switches manufactured and sold by Foundry Networks, Inc. of Santa Clara, Calif.

For the first protocol of the two-stage communication protocol, the Handheld devices 110ₓ transmit and receive some type of media, such as audio, video, text, to other Handheld devices 110x within the same RF network (i.e., first RF network 170₁) via the Base Station 130₁ to which they are connected. For the second protocol of the two-stage communication protocol, the Handheld devices 110ₓ, using the SIP over IP, establish a session with its associated base station 130, impart instructions to the base station such as the intended recipients and transfers the media via RF to the base station 130, which in turn transfers the media to the intended recipients.

Each Handheld device 110ₓ is manufactured with a unique identifying code (discussed in greater detail below) as known to those skilled in the telecommunication arts. In theory, the user 111ₓ of a handheld device 110ₓ logs in to his/her device with a username/password predetermined as unique within the set of usernames known by the local RF network 170ₙ. The base station 130 and handheld devices 110ₓ associate a user's username to the handheld ID on which the user logged on.

Handheld devices 110ₓ are configurable to set the same speech encoding and decoding type (CODEC) as other handheld devices 110ₓ and the base station 130 within an RF network 170ₓ. The configurable capability removes the necessity of supporting the Session Description Protocol (SDP). The handheld devices 110ₓ may be manufactured with a number of CODECS programmed and in one embodiment, the handheld device 110ₓ and base station 130 will be able to adjust the CODEC for that handheld device automatically to improve its Quality of Service.

In one embodiment, the handheld devices 110ₓ are in periodic RF communication with the base station 130ₓ in its RF network 170ₓ. If the Base Station 130ₓ does not receive a “heartbeat” after a pre-determined period, the base station 130ₓ assumes the handheld device 110ₓ has been turned off or is too far from the Base Station 130ₓ to have its signal received. The pre-determined period may be constant (i.e., continuous “heartbeat” signals) or of longer periodicity (i.e., one “heartbeat” signal per minute).

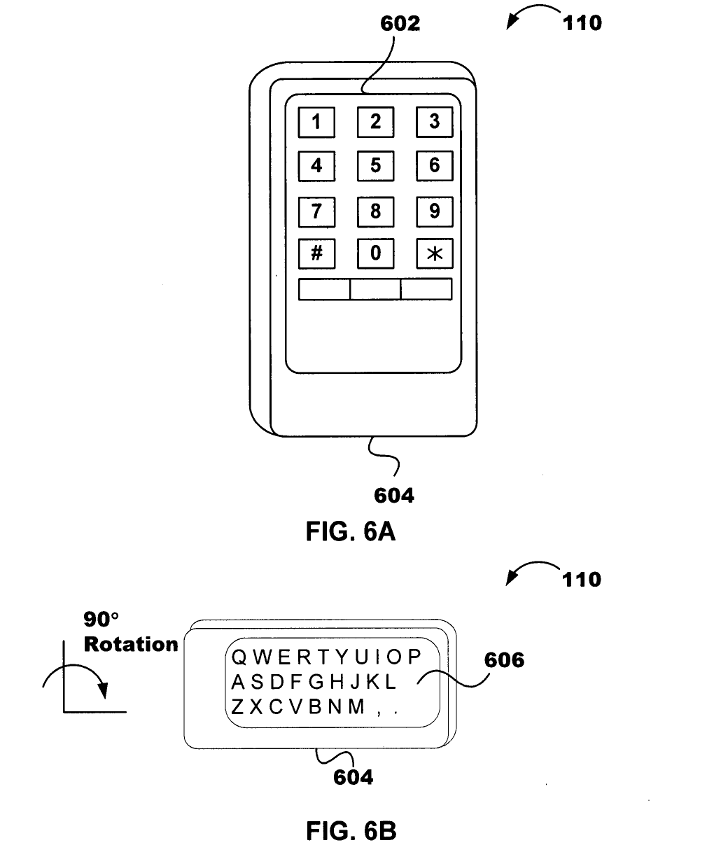

In one embodiment of the invention, the handheld devices 110ₓ are configurable and expandable by their users 111ₓ with actions selected from the group consisting of adding/deleting contacts in an “address book” type application, and adding/deleting groups of users. Such actions are executed via one of more interfaces that are part of the handheld device 110. Detailed discussion and appropriate examples of such interface activity is disclosed in U.S. patent application Ser. No. 11/796,177 filed Apr. 27, 2007 entitled, “Method and Apparatus for Multiple Stage Media Communications” by Smitheimer et al. herein incorporated by reference. Additionally, FIGS. 6A and 6B depict a plurality of different interface screens that are generated in executing a corresponding plurality of different user functions including but not limited to sign on and configurability options. In each instance, a handheld device 110 is depicted as having an interface display screen 604 displaying a functionality appropriate to the action being taken. For example, in one embodiment shown in FIG. 6A, the functionality is shown as a telephone keypad 602. In an alternate embodiment shown in FIG. 6B, the functionality is shown as an alphabetic/QWERTY format keypad 606 having individual buttons for each desired character. To facilitate use and functionality, the display screen can display the various keypads in either an upright fashion as seen with respect to the telephone keypad 602 or in a longitudinal fashion (rotated 90°) as seen with respect to the alphabetic keypad 606. Other input/output features can be incorporated into the handheld device 110 including but not limited to audio speakers, headsets, Bluetooth wireless capability and the like.

Base Stations 130ₓ maintain RF communication with the handheld devices 110ₓ to update a contact list or address book associated with a particular handheld device or provide a broadcast ability in which a base station application may broadcast a message to all of the handheld devices 110ₓ within the RF network 170ₓ. Base Stations 130ₓ monitor the condition of all handhelds 110ₓ within the RF network 170ₓ and may update the address books of users effected by other users. For example, in one embodiment of the invention, one method is to greyout the username in an address book should that user log off or power off their device or move beyond range of the Base Station 130ₓ, or elect a Do Not Disturb (DND) mode on their Handheld device 110ₓ.

Handheld devices 110ₓ associated with the subject invention may communicate with each other indirectly over RF via the base station 110ₓ. Specifically, in one embodiment of the invention, handheld devices transmit and receive on two different frequencies. The base station 130ₓ within the RF network 170ₓ receives on the same frequency the handheld devices 110ₓ transmit. Similarly, the base station 130ₓ within the RF network 170ₓ transmits on the same frequency the handheld devices 110ₓ receive. In this way, interference is eliminated (i.e., one or more handheld devices will not receive a transmission from other handheld devices within transmission range). Another method may be to utilize the Spread Spectrum technologies such as Direct Sequence Spread Spectrum (DSSS) or Frequency Hopping Spread Spectrum (FHSS) as known to those skilled in the art.

FIG. 2 depicts a schematic diagram of an exemplary handheld device 110 that may be used in accordance with and to practice the present invention. The handheld device 110 contains a plurality of components and or modules that facilitate execution of the inventive two stage communication protocol. Specifically, the handheld device 110 includes an RF transmission processor 210 connected to a packet processor 230. In a preferred embodiment of the invention, the packet processor 230 is an IP packet processor.

The RF transmission processor 210 includes the necessary components and/or programming to perform RF transmission and receiving functions of the handheld device 110. In detail, the RF transmission processor 210 includes digital signal processor (DSP) 212 for performing signal modulation/demodulation and encoding/decoding tasks. The DSP 212 is connected to a transmitter means 214 and a receiver means 216 which respectively perform upconverting (analog-to-digital) and downconverting (digital-to-analog), amplification and mixing of signals comprising a voice session between users. The transmitter means 214 and receiver means 216 are also connected to an oscillator 218 which provides the baseband or carrier signal upon which the voice data is mixed or carried. Additionally, each of the transmitter means 214 and a receiver means 216 has an antenna 220/222 for respectively transmitting and receiving signals between users. Alternately, one antenna is used in the RF transmission processor 210. In such an arrangement, a switch (not shown) is connected between the one antenna and receiver means 216 and transmitter means 214. When a button is depressed on the handset 110 (i.e., a Push-To-Talk (PTT) button) or other similar “SEND” or “EXECUTE” command is activated by a user, the transmitter means 214 is connected to the one antenna and when the button is not depressed or the device is idle, the receiver means 216 is connected to the one antenna.

The packet processor 230 includes the necessary components and/or programming to perform processing of data (i.e., converted voice signals) according to SIP in the handheld device 110. The packet processor 230 comprises a central processing unit (CPU) 232, one or more memories 234/236, and support circuits 238 for the CPU 232 and provisions 240/242 for interfacing with the handheld device 110. One example of such provisions may be input/output devices such as a display screen and keyboard. The CPU 232 is connected to the DSP 212 for managing and controlling packet processing. The CPU 232 may be one of any form of a general purpose computer processor used in packet-based networks for executing machine instructions. The memories or computer-readable medium 234/236 are coupled to the CPU 232 and can be one or more of readily available memory such as random access memory (RAM), read only memory (ROM), floppy disk, hard disk, flash memory or any other form of digital storage, local or remote. The support circuits 238 are coupled to the CPU 232 for supporting the packet processor in a conventional manner. These support circuits include cache, power supplies, clock circuits, input/output circuitry and subsystems, and the like.

The packet processor 230 further includes a plurality of modules for dedicated task processing. In one embodiment of the invention, the plurality of modules is selected from the group consisting of a Media Handler module 244, a SIP processing module 246 and a Real Time Protocol (RTP) Handler module 254. Specifically, these modules are represented as dedicated software routines contained in at least one of the memories 234/236. Such modules will cause the packet processor 230 to perform processes necessary to the present invention. For example, the SIP processing module 246 is executed to handle SIP-related communication functions, the Media Handler module 244 is executed to handle different types of media (i.e., voice, video, speech to text, text to speech, etc.) and the Real Time Protocol (RTP) Handler module 254 is executed to handle RTP-related media functions. Other modules included in the memory 234/236 include a softphone or similar SIP voice client application, an email client application, a browser client application, an instant messaging (IM) client, a database of contacts and a log(s) of calls (placed, received, missed and the like).

A general software routine 252, when executed by the CPU 232, causes the packet processor 230 to perform processes of the present invention (such as but not limited to setting up and tearing down voice communication sessions described in greater detail below and calling one or more dedicated software routines such as but not limited to those identified above) and is generally stored in one or more of the memories 234/236. The software routine 252 may also be stored and/or executed by a second CPU (not shown) that is remotely located from the hardware being controlled by the CPU 232. For example, the software routine 252 may be stored (in part) in a memory of the handheld device 110 and stored (in part) in a memory of the base station 130ₓ (described in greater detail below). The software routine 252, when executed by the CPU 232, transforms the handheld device 110 into a specific purpose computer that performs voice communications via the two stage communication protocol. Although a portion of the present invention is discussed as being implemented as a software routine, some of the method steps that are disclosed may be performed in hardware as well as by the packet processor 230. As such, the invention may be implemented in software as executed upon a computer system, in hardware as an application specific integrated circuit or other type of hardware implementation, or a combination of software and hardware.

The software routine 252 of the present invention is capable of being executed on computer operating systems including but not limited to Microsoft Windows 98, Microsoft Windows XP, Apple OS X and Linux. Similarly, the software routine 252 of the present invention is capable of being performed using CPU architectures including but not limited to Apple Power PC, Intel x86, Sun SPARC and Intel ARM.

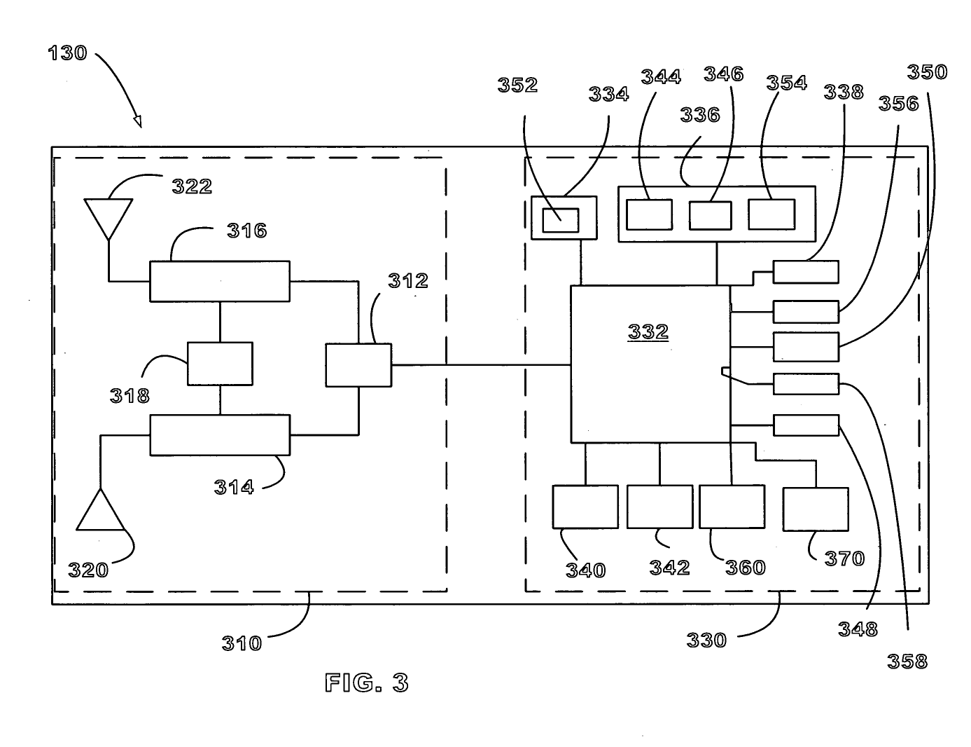

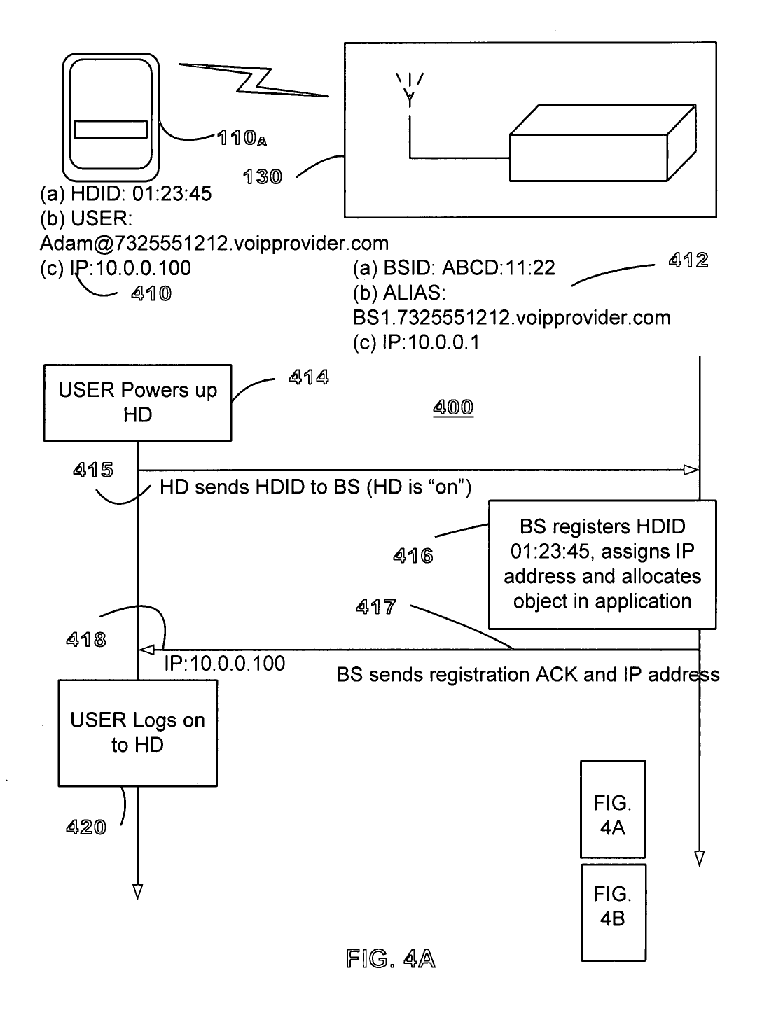

FIG. 3 depicts a schematic diagram of an exemplary base station server 131 that may be used in accordance with and to practice the present invention. The base station server 131 contains a plurality of components and or modules that facilitate execution of the inventive two stage communication protocol. It is noted that all components identified in the handheld device 110 have corresponding components in the base station server 131 with corresponding interconnection and function; hence, they need not be specifically repeated herein but are briefly described. Specifically, the base station server 131 includes an RF transmission processor 310 connected to a packet processor 330. The RF transmission processor 310 includes the necessary components and/or programming to perform the RF transmission and receiving functions of the base station server 131. The RF transmission processor 310 includes digital signal processor (DSP) 312 similar in form and function to that of the handheld device 110. The DSP 312 is connected to a transmitter means 314 and a receiver means 316 similar in form and function to that of the handheld device 110. The transmitter means 314 and receiver means 316 are also connected to an oscillator 318 similar in form and function to that of the handheld. Additionally, each of the transmitter means 314 and a receiver means 316 has an antenna 320/322 for respectively transmitting and receiving signals between users although a single antenna may alternately be employed as described above with respect to the handheld device 110.

The packet processor 330 includes the necessary components and/or programming to perform processing of data (i.e., converted voice signals) according to the type of communication session requested. In one embodiment (a SIP-driven request) the base station server 131 executes at least SIP related commands to satisfy the request. In an alternate embodiment (a non-SIP request), the base station server 131 executes router type functions associated with digital packet processing as known in the art to satisfy the request. The packet processor 330 comprises a central processing unit (CPU) 332, one or more memories 334/336, support circuits 338 for the CPU 332 and provisions 340/342 for interfacing with the base station server 131. Such provisions may be input/output devices selected from the group consisting of a display screen, a keyboard, a microphone and an audio transducer (i.e., speaker). In one embodiment where one of the provisions is a display screen, such screen can show status information such as but not limited to telephone call signaling progress, Caller ID, time and menu configuration. In one embodiment, one of the provisions can be a keypad (or touchscreen simulating keypad characteristics) for entering telephone numbers, base station configuration parameters and the like. One or more auxiliary input/output devices 370 may also be provided such as but not limited to a serial port and a network management port. Additional network ports may be used to cross-connect two base stations in an active-active or active-passive high availability configuration. An alternate auxiliary input/output device 370 can be a corded or cordless handset that is non-configurable (as described in greater detail below) for the purposes of a “guest” or other non-resident use. The “guest” may be allowed to place or receive calls or otherwise have some limited use without requiring log in authentication based upon a preset profile or configuration file.

The CPU 332 is connected to the DSP 312 for managing and controlling packet processing. The CPU 332 may be one of any form of a general purpose computer processor used in packet-based networks for executing machine instructions. The memories or computer-readable medium 334/336 are coupled to the CPU 332 and can be one or more of readily available memory such as random access memory (RAM), read only memory (ROM), floppy disk, hard disk, flash memory or any other form of digital storage, local or remote. The support circuits 338 are coupled to the CPU 332 for supporting the packet processor in a conventional manner. These support circuits include cache, power supplies, clock circuits, input/output circuitry and subsystems, and the like.

Similar to the handheld device packet processor 230, the base station packet processor 330 further includes a Media Handler module 344, a SIP processing module 346 and an RTP Handler module 354 all of which are similar in form (software representations in one or more memories 334/336) and function to that described for the handheld device 110. Additionally, the base station packet processor 330 further includes a database 348 for managing user information (i.e., user log in information, a list of permitted users, contact information/updates, storage of transient and permanent data such as but not limited to current session information and persistent group association, handheld ID user association (i.e., to an IP address that is assigned during the log in process), status of handheld devices, ON/OFF, DND settings by user and the like), “white list” and “black list” phone numbers or prefixes on a user basis and the like. Also included is an administration module 360 for managing basic system functions apart from the actual voice sessions (i.e., providing software for local administration of the base station 130) and a network module 350 for managing one or more network interfaces. Other modules included in the memory 334/336 include a softphone or similar SIP voice client application, an email client application, a browser client application, an instant messaging (IM) client, a database of contacts and a log(s) of calls (placed, received, missed and the like). A proxy server 356 acts as a local proxy for the handheld devices 110 to interface with points outside the system 100. Further, a DHCP server 358 provides IP addresses to each handheld device 110 during log in.

A software routine 352, when executed by the CPU 332, causes the packet processor 330 to perform processes of the present invention (such as but not limited to setting up and tearing down voice communication sessions described in greater detail below and calling one or more dedicated software routines such as but not limited to those identified above) and is generally stored in one or more of the memories 334/336. The software routine 352 may also be stored and/or executed by a second CPU (not shown) that is remotely located from the hardware being controlled by the CPU 332. For example, the software routine 352 may be stored (in part) in a memory of the base station server 131 and stored (in part) in a memory of the handheld device 110. The software routine 352, when executed by the CPU 332, transforms the base station 131 into a specific purpose computer that performs voice communication according to the two stage communication protocol. Although a portion of the present invention is discussed as being implemented as a software routine, some of the method steps that are disclosed may be performed in hardware as well as by the packet processor 330. As such, the invention may be implemented in software as executed upon a computer system, in hardware as an application specific integrated circuit or other type of hardware implementation, or a combination of software and hardware. Additionally, the handheld device software routine 252 and the base station software routine 352 may be considered as one two stage communication protocol software routine having specific or dedicated modules for executing handheld-specific and base station-specific tasks for the purposes of the subject invention.

The software routine 352 of the present invention is capable of being executed on computer operating systems including but not limited to Microsoft Windows 98, Microsoft Windows XP, Apple OS X and Linux. Similarly, the software routine 352 of the present invention is capable of being performed using CPU architectures including but not limited to Apple Power PC, Intel x86, Sun SPARC and Intel ARM.

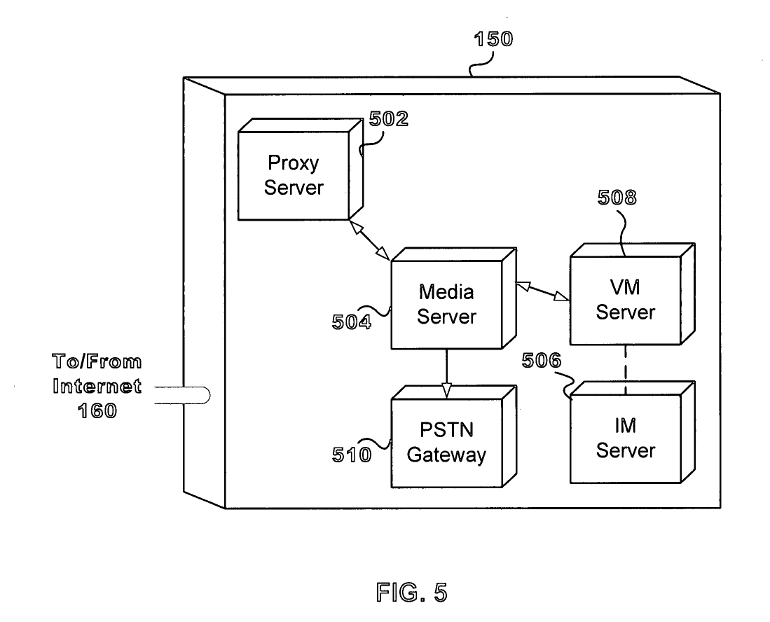

As identified earlier, the multi-media communications system 100 is connected to at least one content/service provider 150x. One possible configuration of the connections that make up such an arrangement is depicted in FIG. 5. FIG. 5 shows a detailed view of the organization of a content/service provider associated with the subject invention. In a preferred embodiment of the invention, the multi-media communications system 100 is connected to a preferred content/service provider 150, via a proxy server 502. The proxy server 502 acts as an intermediary between the localized network/environment (communications system 100) and additional servers in the preferred content/service provider 150. Additional servers add features or content to the overall customer experience by providing users 111x access to different types of communication sessions. The additional servers connected behind the proxy server 502 include but are not limited to a Media Server 504 for providing different types of media (i.e., voice, video, speech to text, text to speech, etc.); an Instant Messaging (IM) server 506 for establishing and maintaining “chat” type communication sessions and a voicemail server 508 for providing voicemail capability to the user. Of course other types of servers are possible to increase the type and level of service or content that is desired. There can also optionally be a PSTN Gateway server 510 for the processing and facilitating of communications between the multi-media communications system 100 and the third parties having a connection to the PSTN (not shown). Since all of the additional servers are part of the preferred content/service provider 150, levels of service, introduction of new content or services and the like are easily controlled; provided and billed to users 111 of the preferred content/service provider 150. Additionally, there may be at least one non-preferred content/service providers such as web servers 1603, and third party email servers 1604 and IM servers 1602 that do not make up the preferred content/service providers offerings, but are still accessible via connection to the Internet 160 as seen in FIG. 1.

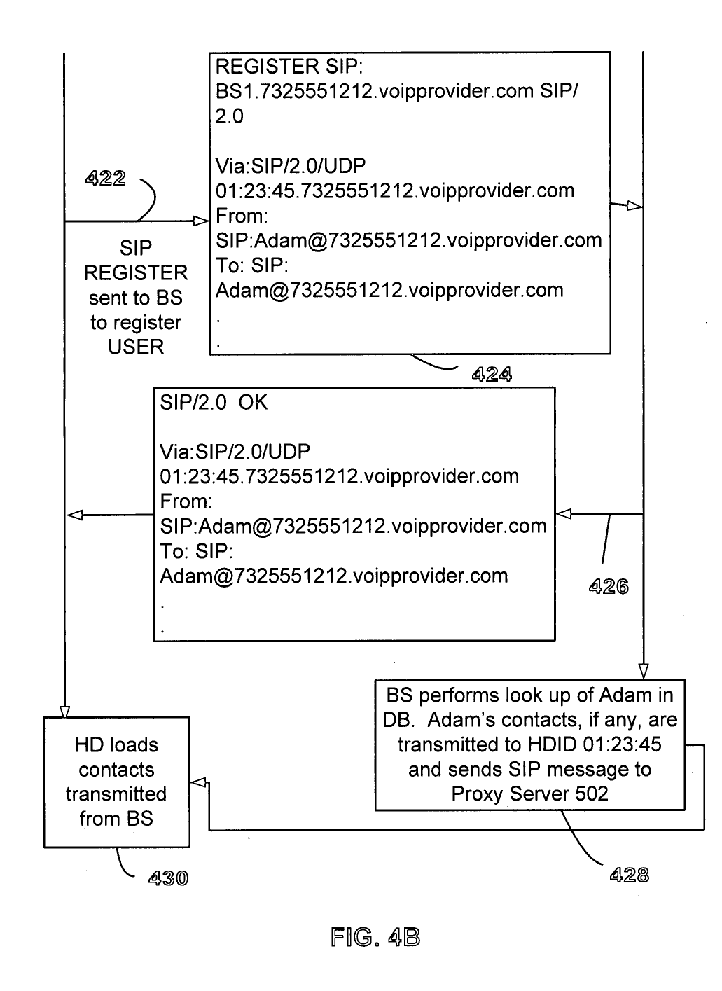

FIG. 4 depicts an exemplary use of the two stage communication protocol of the subject invention. Specifically, FIG. 4 depicts the data flow of a handheld device/user registration process 400. To facilitate understanding of the invention, the following description of the data flows and attendant processes of FIG. 4 includes names to identify one or more of the users 111n and their respective handheld devices 110n discussed earlier. In one embodiment of the invention, the name “Adam” is associated with a first user 111_{A}, the name “Don” is associated with a second user 111_{D} and the name “Alex” is associated with a third user 111_{AX}.

Initially in the handheld device/user registration process 400, Adam has a handheld device 110 currently powered off and having an ID profile 410. Adam powers on the handheld device at step 414. During the device's operating system boot process at step 415, the handheld device 110 registers itself with the nearest or only base station 130 within its vicinity by sending the handheld device's ID #410A (e.g. 01:23:45) via an RF transmission. The base station 130 receives the RF transmission with embodied instructions requesting registration in a digitally encoded, non-SIP manner known to those skilled in the art. The base station 130 (in a previously booted-up condition prior to the Handheld 410 power on), is pre-configured with a profile 412 having a unique ID #, 412a, network alias or FQDN 412b and a IP address 412c.

The base station 130 registers the handheld 110 at step 416. In one embodiment, this registration occurs by allocating memory 334 to the database 348 for the handheld 110, assigning an IP address 410c to the handheld 110ₓ and updating the database 348 with such IP address. The base station 130 responds to the handheld 110 with an acknowledgement code and the IP address in step 417. The handheld 110 receives the acknowledgment code and IP address at step 418, incorporates the IP address into its configuration, and completes the boot process presenting Adam with a login message. Security metrics are in place during the login process to prevent unauthorized individuals from gaining access to the communication system 100. Security metrics are selected from the group consisting of a biometric ID scan, a retinal ID scan, a thumbprint scan, an analog dial interface, GPS location and any combination of the aforementioned.

At step 420, Adam enters his username on handheld 110 and enters or executes the appropriate security metric. This action sends a SIP REGISTER message to the base station 130 at step 422. Record 424 depicts an exemplary SIP REGISTER message record which includes the SIP REGISTER instruction. At step 426, the base station 130 responds with a SIP OK message. Additionally, its application looks up Adam in its Database 348 for contact information, profile information (such as custom default settings, backgrounds, colors, ringtones and the like) and transmits such information if it exists, to the handheld 110, at step 428. At step 430, the handheld 110 receives the contact information, if any, and loads it into its memory 234 thereby completing the registration process. Moreover, the otherwise generic handheld device 110 is now reconfigured for Adam's express use in a manner he has predetermined. When Adam logs off of the handheld device 110, Alex may pick it up and, if an authorized user, login to the communication system 100 and the system will reconfigure the handheld device 110 to Alex's predetermined settings thereby providing a repeatable configurable condition for any of the authorized users. In one embodiment of the invention, unauthorized users (i.e., guests of the residence) may be given a restricted access login with a profile that does not grant access to as many features or provide for the same level of customization as authorized users.

In operation, it is understood that there are at least two types of functions that correspond to different types of communication sessions possible with system 100. The two types of functions are selected from the group consisting of SIP application functions and media (or non-SIP) functions. Stated simply, SIP application functions require action by the proxy server 502 of the content/service provider 150 in order to satisfy user requests while media functions are satisfied by means other than via the proxy server 502. In SIP application functions (such as a softphone client application), the handheld device 110 generates SIP messages according to RFC 3261. The handheld device 110 incorporates user log-in names in SIP messages to provide the base station means 130 with a mean to route communication sessions (telephone calls) to the intended recipient. Examples of such formatting includes using a password token (e.g., 7325551212:sara@voipprovider.com), incorporating the telephone number as part of a given domain thereby creating a subdomain (e.g., sara@7325551212.voipprovider.com and placing the user name in the subject field SIP header and incorporating the user name in the SIP URI (e.g., 7325551212@voipprovider.com;user=sara). During such SIP application functions, the base station means 130 operates as a proxy server in the local environment or network 120 to forward SIP messages to and from one or more hand held devices 110 or auxiliary base station 130₂₋ₙ based on the user name contained within the SIP message.

The base station means 130 decodes SIP to acquire user information, looks up the user in the local database 334/336 to find IP addresses assigned to one or more handheld devices 110 and forwards SIP messages over RF to the appropriate handheld device. SIP application functions (such as voice, video and possibly IM are transmitted and received at the base station means via RF. Voice uses SIP/UDP while video and IM may use SIP/TCP or UDP protocols. In media functions, the base station means 130 receives media encoded with the IP address of a handheld device 110 (e.g. from the Internet 160 or other source), looks up the IP address in its database 334/336 and forwards the content to the appropriate handheld device 110. In the reverse direction, information or requests from the handheld device 110 contain at least the destination IP address of the intended recipient of the content or communication session. In such non-SIP application functions, information is digital and optionally encrypted and sent via RF to the base station means 130. At that point, data packets containing the digital information is evaluated by a destination server and relayed via RF to the appropriate handheld device 110.

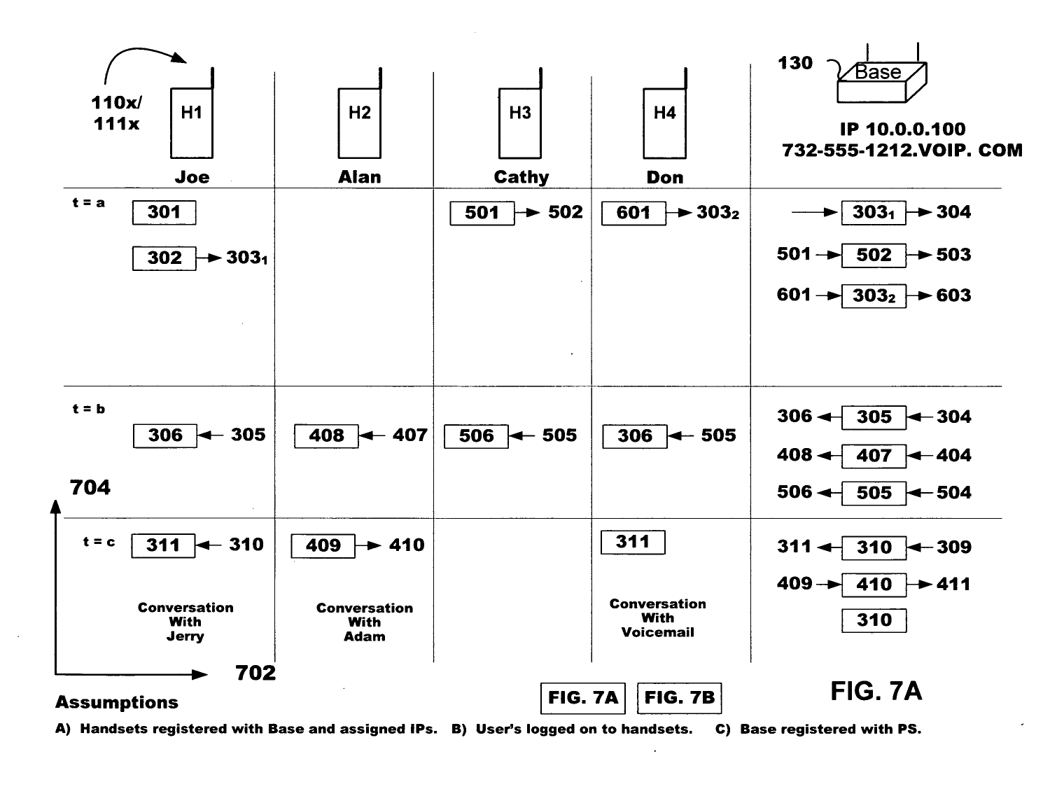

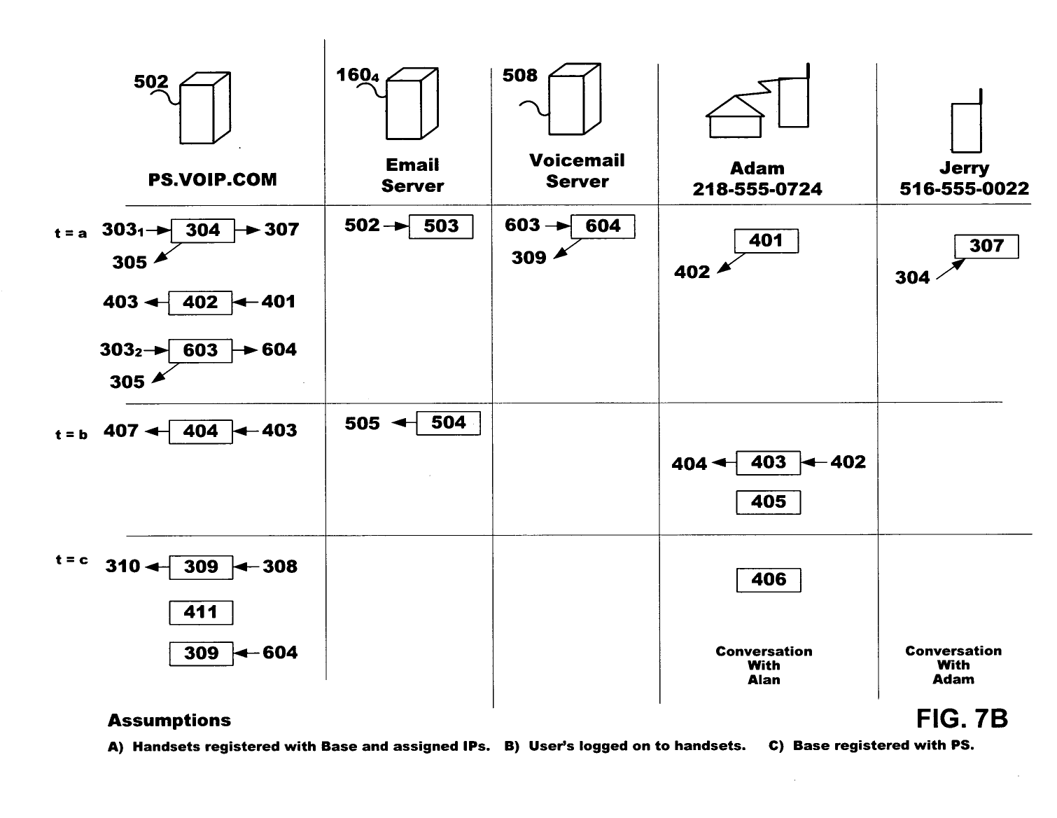

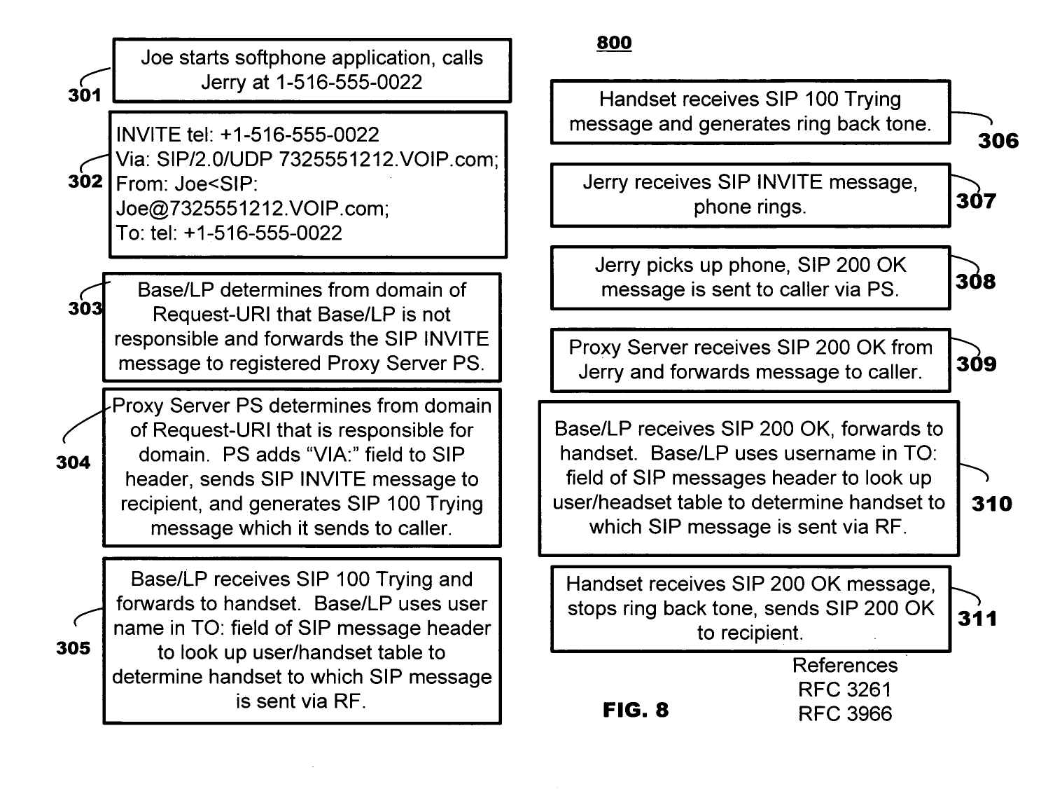

FIG. 7 is a chart depicting the various types of communication sessions that occur during operation of the subject invention thereby conveying the flexibility of the communication system 100 over ordinary residential PSTN service. Specifically, FIG. 7 depicts a chart 700 of interacting entities along a horizontal axis 702 at different times t=a, t=b and t=c along a vertical axis 704. The entities are selected from the group consisting of users 111 and their corresponding devices 110, the base station means 130, the proxy server 502, the third party email server 1604; the preferred content service provider voicemail server 508 and other endpoints 706 and 708 outside of the communication system 100. Cells in the chart denote activity by a numbered tag xxx. The numbered tag xxx includes a full written description of the activity occurring in the corresponding charts of FIGS. 8-11 depending on the activity as described in detail below. The tags xxx show the progress of a particular activity as the requesting communication session is handed off from on part of the communication system 100 to another.

For example, if there is outgoing telephone activity, FIG. 8 is referenced. FIG. 8 is a chart 800 detailing the activity associated with a softphone application making an outgoing telephone call. Specifically, a series of communication activities (3xx's) occurs as a request for an outgoing telephone call moves from user Joe (associated with handheld device H1) to the base station means 130, proxy server 502, outside endpoint 708 (Jerry's cell phone) at a time t=a. At a time t=c, response messaging works its way back through the communication system to finally initiate a conversation with Jerry.

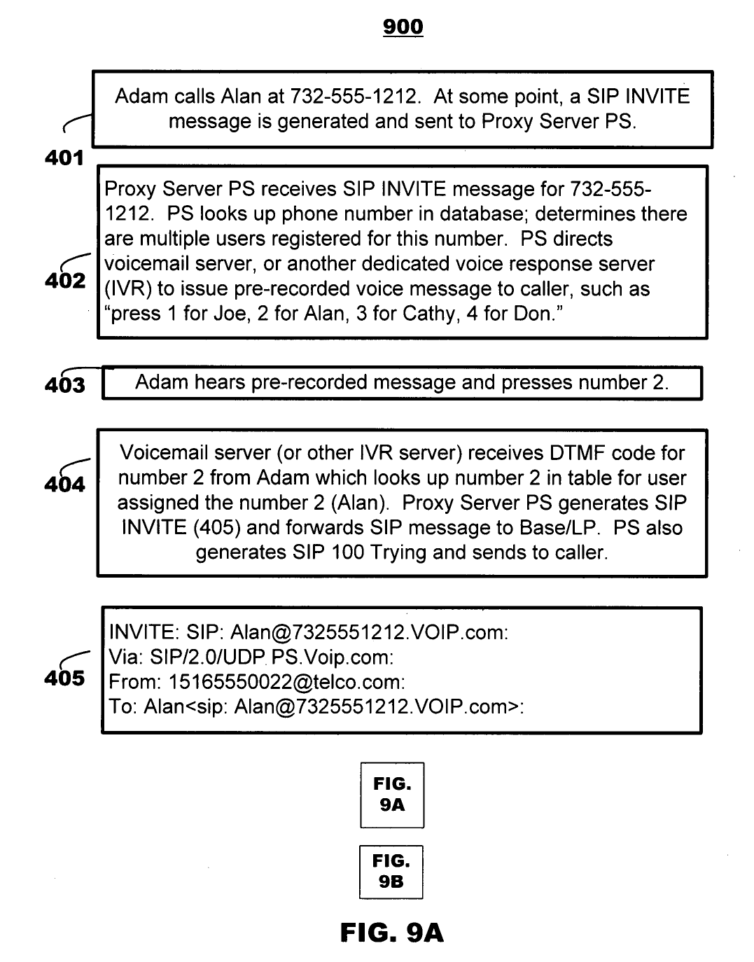

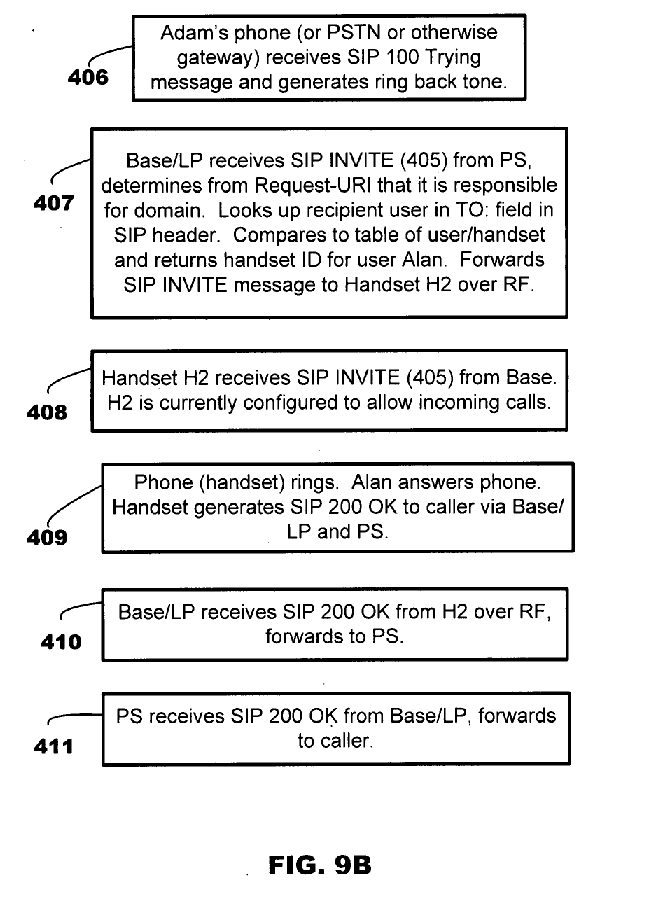

Similarly, if there is incoming telephone activity, FIG. 9 is referenced. FIG. 9 is a chart 900 detailing the activity associated with a softphone application involved in an incoming telephone call. Specifically, a series of communication activities (4xx's) occurs as a request for an incoming telephone call moves from outside endpoint 706 (Adam's home phone) to the proxy server 502 at time t=a. Messaging goes back to Adam briefly for user selection, to the proxy server 502 again, to the base station means 130 and to user Alan (associated with handheld device H2) at time t=b. At a time t=c, response messaging through the communication system 100 initiates a conversation with user Alan.

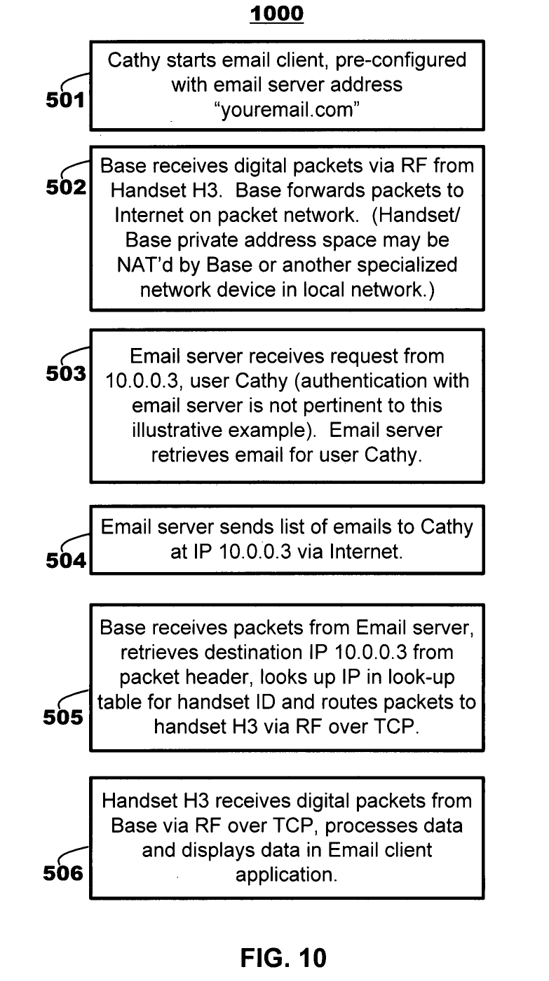

Similarly, if there is email client, FIG. 10 is referenced. FIG. 10 is a chart 1000 detailing the activity associated with an email client application. Specifically, a series of communication activities (5xx's) occurs as a request for an external (i.e., not associated with the preferred content service provider 150) email client is initiated by user Cathy associated with handheld device H3. A request for the email client moves from user Cathy to the base station means 130, third party email server 1604 at a time t=a. At a time t=b, messaging works its way back through the communication system 100 to finally initiate an email session with Cathy. Note that the proxy server 502 is not included in the messaging of this request because of the non-SIP nature (third party destination) of the communication requested.

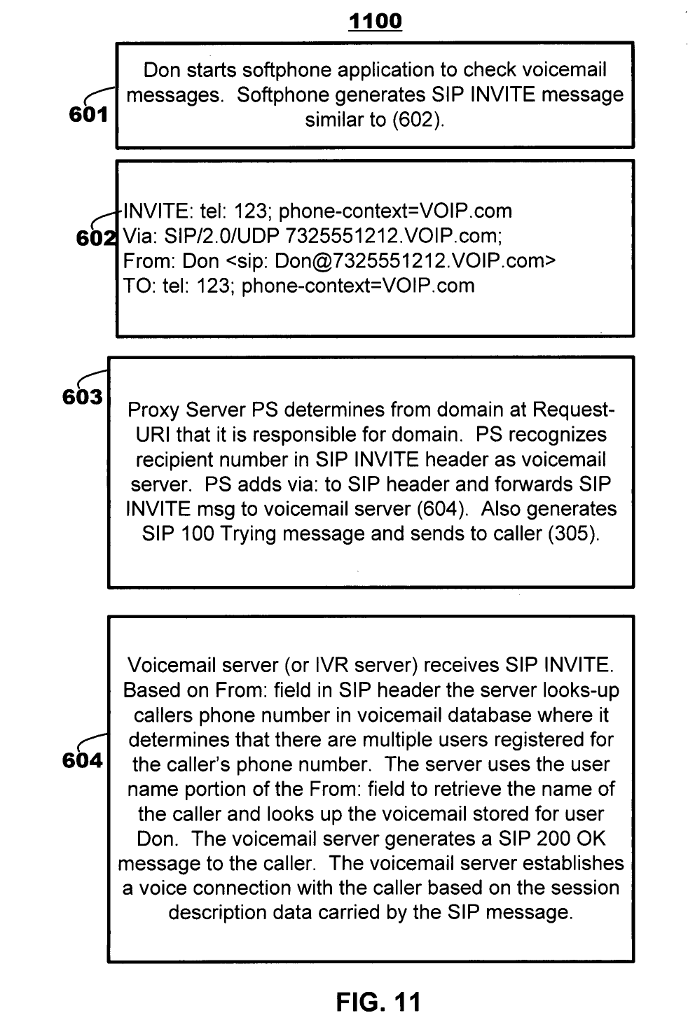

Similarly, if there is outgoing voicemail activity, FIG. 11 is referenced. FIG. 11 is a chart 1100 detailing the activity associated with a voicemail client application. Specifically, a series of communication activities (6xx's) occurs as a request for voicemail moves from user Don (associated with handheld device H4) to the base station means 130, proxy server 502 and preferred content/service provider voicemail server 508 at time t=a. At a time t=c, response messaging works its way back through the communication system 100 to finally initiate a session with the voicemail server 508. Note that some of the return path messaging for voicemail service is similar or identical to that of outgoing telephone calls (seen in chart 800 and explained above); therefore the return path messaging is identified by 3xx's and not 6xx's.

Chart 700 depicts various activities occurring at the same time (e.g., various requests occurring at t=a and being satisfied at t=c). This is simply not possible in a PSTN system that has only one or perhaps two channels or phone lines available for communication sessions. Even if so, via DSL service, the added cost of extra lines and the DSL service may be prohibitive and still limit the number of possible concurrent users at any one time. The present invention is not limited in this manner as it can use a single phone number as a domain and grant access to as many users as there are handheld devices 110 available. Additionally, using prior telecommunication services assumes a networked computer which may be too large or cumbersome or not sufficiently weather-resistant to successfully accompany a mobile user within the confines of the communication system 100. Moreover, existing mobile communication systems fail to provide the flexibility of the present invention in that devices associated therewith are not easily re-assignable to another user as are the handheld devices 110 of the subject invention. That is, once a handheld device 110 is logged off (or otherwise times out) of its current users session, another authorized user may simple activated the same device, log in to the communication system 100 and have all available services and user-defined features in such same device.

While foregoing is directed to embodiments of the present invention, other and further embodiments of the invention may be devised without departing from the basic scope thereof, and the scope thereof.

1. A system for multi-media communications comprising:
a handheld wireless means for transmitting and receiving media communications; and
a base station means for relaying the media communications to a multi-media communications service provider;
wherein the handheld wireless means is repeatably configurable to any one of a plurality of users associated with the system.

2. The system of claim 1 wherein the transmitting and receiving of the media communications between the handheld wireless means and the basestation means is via a two-stage communications protocol.

3. The system of claim 2 wherein the two-stage communications protocol further comprises a first RF-based stage and a second IP-based stage.

4. The system of claim 3 wherein the second IP-based stage uses SIP for establishing media communications between the handheld means and the basestation means.

5. The system of claim 4 wherein the wireless handheld device further comprises an RF transmission processor and an IP packet processor.

6. The system of claim 4 wherein the base station device further comprises an RF transmission processor and an IP packet processor.

7. The system of claim 1 wherein the multimedia communications service provider further comprises:
a proxy server for receiving and directing communications requests and
a plurality of communications servers each providing access to a different form of media/communications.

8. The system of claim 7 wherein the plurality of communications servers is selected from the group consisting of a voicmail server, an Instant Messaging (IM) server and a media session server.

9. The system of claim 8 wherein the media session server further includes access to session servers selected from the group consisting of a voicemail server and an instant messaging server.

10. The system of claim 1 wherein the base station means further comprises one or more connection means to third party communication service providers.

11. The system of claim 1 wherein the media is selected from the group consisting of audio, video, text/SMS messages and data.

12. The system of claim 1 wherein the handheld wireless means are repeatably configurable using security metrics that equate one user associated with the system to at least one user profile maintained at the communications service provider.

13. The system of claim 12 wherein the security metrics are selected from the group consisting of a biometric ID scan, a retinal ID scan, a thumbprint scan, a analog dial interface and GPS location.

14. The system of claim 1 wherein the handheld wireless means further comprises a display means that automatically configures itself according to a user requested communication session.

15. The system of claim 14 wherein the display means is a touch screen that autoconfigures to one selected from the group consisting of a numeric keypad for telephone style communications and an alpha/QWERTY keyboard for text style communications.
